(19) United States
(12) Patent Application Publication
(10) Pub. No.: US 2014/0084812 A1
(43) Pub. Date: Mar. 27, 2014

(54) DEVICE AND METHOD FOR LIGHT ADJUSTING FOR A LARGE-SCALE PARKING

(71) Applicant: DELIVERER OPTICAL CO., LTD., New Taipei City (TW)

(72) Inventor: Ching-Heng Tang, New Taipei City (TW)

(73) Assignee: DELIVERER OPTICAL CO., LTD., New Taipei City (TW)

(21) Appl. No.: 13/776,642

(22) Filed: Feb. 25, 2013

(30) Foreign Application Priority Data
Sep. 21, 2012 (TW) 101218295

(51) Int. Cl. H05B 37/02

(52) U.S. Cl. CPC H05B 37/02
USPC 315/307

(57) ABSTRACT

An approach is provided for a device and a method for light adjusting that adjust illumination output based on the environment statues, which comprises a power supply, at least one detector, and at least one controller. The detector is configured for detecting an object in a detecting region. The controller is coupled to the power supply, the detector and a LED lamp, and is configured to provide adaptive power to the LED lamp based on the detections of the detector, wherein the controller provides a high voltage to the LED lamp when the object is detected by the detector. Therefore, it is able to reduce electricity consumption especially for a place requiring long term illumination.

### FIELD OF THE INVENTION

Embodiments of the present invention relate to a dimmable lighting system, especially toward a device and a method for light adjusting for a large-scale parking lot and/or parking garage.

### BACKGROUND

For a long term lighting environment, such as a parking lot and/or garage, usually need a lighting system to provide a required illumination and a better view for drivers all day due to no windows set up. However, the parking lot has a larger area, requires a great quantity of lighting apparatus and always causes unnecessary electricity waste.

Conventional lighting apparatuses, such as a fluorescent lamps or a bulb, are gradually eliminated and replaced by a light emitting diode (LED) due to the environment protection requirements. The LED has characteristics of power saving, better lighting, long life cycling and is complied with the environment protection requirements, so that the LED is became a focused research target to improve the lighting ability and power saving possibility.

Although the LED already has better power saving capability than the conventional lighting apparatus, the lighting requirement of the long term lighting environment still has to consume large electricity.

Therefore, there is a need to develop a adjustable lighting system to provide an appropriate lighting brightness based on the environment requirement to efficiently improve disadvantages of electricity consumption.

### SOME EXEMPLARY EMBODIMENTS

These and other needs are addressed by the present invention, wherein an approach is provided for a device and a method for light adjusting that adjust illumination output based on the environment statues, which reduces electricity consumption especially for a place requiring long term illumination such as indoor parking lot.

According to one aspect of an embodiment of the present invention, a device for light adjusting for a large-scale parking lot comprises a power supply, at least one detector, and at least one controller. The detector is configured for detecting an object in a detecting region. The controller is coupled to the power supply, the detector and a LED lamp, and is configured to provide adaptive power to the LED lamp based on the detections of the detector, wherein the controller provides a high voltage to the LED lamp when the object is detected by the detector.

According to another aspect of an embodiment of the present invention, a method for adjusting for a large-scale parking comprises acts S40 detecting a moving object in a detecting region, S41 generating a first signal to power a high DC voltage to a corresponding LED lamp when the moving object is detected; and S42 generating a second signal to power a low DC voltage to the corresponding LED lamp when the moving object is no longer detected for a predetermined period.

Accordingly, the present invention is able to be applied at an environment that is divided into multiple regions or segments. Each has an individual adjustable lighting criterion. Therefore, each region has capability to adjust the brightness depends on actual requirement.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a perspective view of a device for light adjusting for a large-scale parking lot in accordance with the present invention;

FIG. 2 is a flow chart of a method for light adjusting for a large-scale parking in accordance with the present invention.

### DESCRIPTION OF THE PREFERRED EMBODIMENT

A lighting system is disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

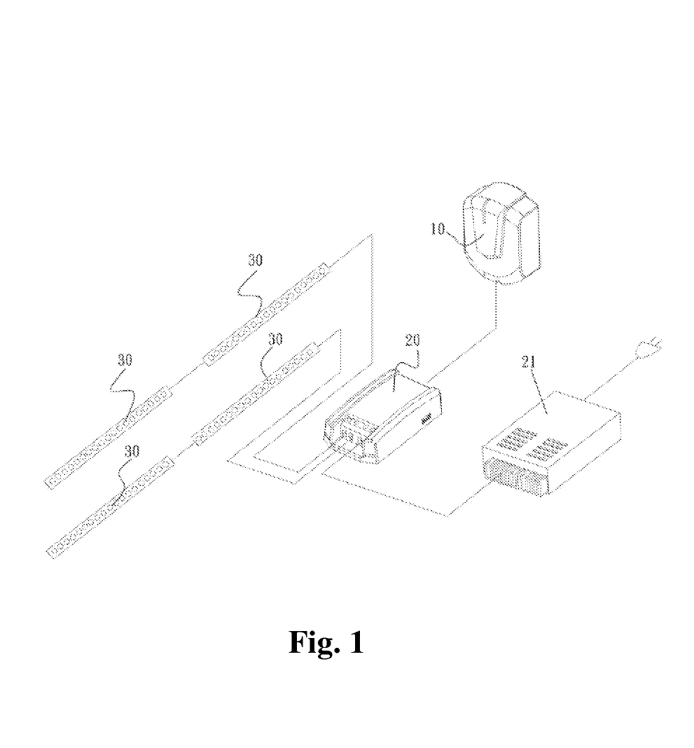

With reference to FIG. 1, FIG. 1 shows a perspective view of a device for light adjusting for a large-scale parking lot in accordance with the present invention. In this embodiment, the device comprises a power supply 21, at least one detector 10, and at least one controller 20. The detector 10 is configured for detecting an object in a detecting region. The controller 20 is coupled to the power supply 21, the detector 10 and a LED lamp 30, and is configured to provide adaptive power to the LED lamp 30 based on the detections of the detector 10, wherein the controller 20 provides a high voltage to the LED lamp 30 when the object is detected by the detector 10.

In this embodiment, as shown in FIG. 1, the controller 20 comprises multiple ports connected to multiple corresponding LED strips of the LED lamp 30. The illumination (brightness) of the LED strips is adjustable whereby providing different levels of Direct Current (DC) voltages. The adaptive power to the LED lamp 30 is provided by the power supply 21 which is converted by the controller 20 and is switchable for a person from multiple preset DC voltages from High to Low voltage.

The detector 10 is connected to the controller 20 and indicates the controller 20 to adjust proper level of DC voltage to the LED lamp 30 for dimmer illumination. In general, the controller 20 provides lowest level of the DC voltage to the LED lamp 30 in order to achieve minimum power consumption. The detector 10 generates a first signal to the controller 20 when an object has been detected, and the controller 20 provides higher DC voltage once the first signal is received. The higher DC voltage will continues for a predetermined period that makes the LED lamp 30 to provide better illumination temperately. In some examples, the detector may use radars, infrared rays, or acoustic wave for detection.

However, it is noted that a person skilled may realize that the detector 10 may communicate to more than one controller 20, or multiple detectors 10 communicate with a single controller 20. The connections between the controller 20 and the detector 10 may via wire or wireless communications.

Moreover, in one embodiment, when the LED lamp 30 receives higher DC voltage and no object has been detected by the detector 10 for the predetermined period, the detector 10 will generate a second signal to the controller 20 that indicates the controller 20 to adjust the adaptive power back to the lower DC voltage. In an example, the predetermined period for the controller 10 to selectively send out the first or second signal may be 5 to 10 seconds.

Accordingly, the adaptive power to the LED lamp 30 is controlled by the controller 20 in response to the detections of the detector 10, which is capable of avoiding electricity waste in an unnecessary condition and of efficiently saving the electrical resource.

In this manner, the embodiment of the present invention is able to use in large scale space such as indoor parking garage or parking lot, which divides the space into several segments with corresponding controllers 20 and detectors 10. When a car is driving through a specific segment that is detected by the detector 10, the detector 10 will send out the first signal to make the LED lamp 30 brighter as to the driver for better sight. Simultaneously, for other segments of the parking lot do not have the driving cars or people, the LED lamps 30 are driven by the lowest DC voltage as a default input voltage to maintain minimum illumination for power saving.

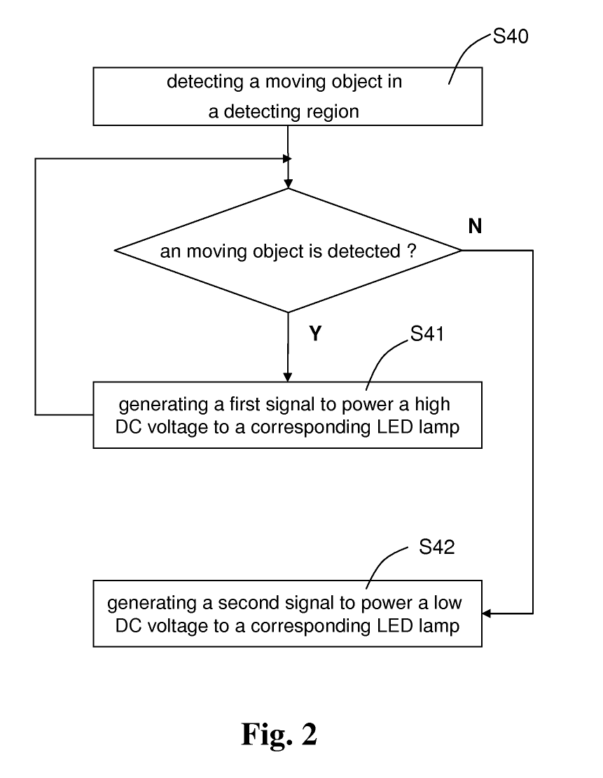

Accordingly, with reference to FIG. 2, FIG. 2 is a flow chart of a method for light adjusting for a large-scale parking in accordance with the present invention. In this embodiment, the method is adaptive for above mentioned device embodiment which comprises acts of S40 detecting a moving object in a detecting region, S41 generating a first signal to power a high DC voltage to a corresponding LED lamp when the moving object is detected; and S42 generating a second signal to power a low DC voltage to the corresponding LED lamp when the moving object is no longer detected for a predetermined period. The moving object may be a driving car or a person.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A device for light adjusting for a large-scale parking comprising:
a power supply;
at least one detector, each detector being configured for detecting an object in a detecting region; and
at least one controller, each controller being coupled the power supply, the detector and a LED lamp, and being configured to provide an adaptive power to the LED lamp based on the detection of the detector, wherein the controller provides a high voltage to the LED lamp when the object is detected by the detector.

2. The device as claimed in claim 1, wherein the adaptive power to the LED lamp is provided by the power supply which is converted by the controller.

3. The device as claimed in claim 1, wherein the controller comprises multiple preset DC voltages that is switchable for a person.

4. The device as claimed in claim 1, wherein the controller has multiple ports connected to multiple corresponding LED strips of the LED lamp.

5. The device as claimed in claim 1, wherein the detector is communicated to more than one controller via wire or wireless communications.

6. The device as clamed in claim 1, wherein the controller is communicated among multiple detectors via wire or wireless communications.

7. The device as claimed in claim 1, wherein detector is a detector selected from a group consisting a radar, an infrared ray, and an acoustic wave.

8. A method for light adjusting for a large-scale parking comprising:
detecting a moving object in a detecting region;
generating a first signal to power a high DC voltage to a corresponding LED lamp when the moving object is detected; and
generating a second signal to power a low DC voltage to the corresponding LED lamp when the moving object is no longer detected for a predetermined period.

9. The method as claimed in claim 8, wherein the low DC voltage is provided as a default input voltage for the LED lamp.

10. The method as claimed in claim 8, wherein the moving object is a driving car or a person.
